(19) United States
(12) Patent Application Publication
(10) Pub. No.: US 2013/0273489 A1
(43) Pub. Date: Oct. 17, 2013

(54) Adapter Device for Extension of Mini-Plates, Pliers for the Attachment Thereof and Method for Extension and Attachment of Mini-Plates

(71) Applicants: Luciane Macedo De Menezes, Porto Alegre (BR); Tatiana Siqueira Gonçalves, Porto Alegre (BR); André Weissheimer, Porto Alegre (BR); Eduardo Martinelli Santayana De Lima, Porto Alegre (BR); Susana Maria Deon Rizzatto, Porto Alegre (BR); Mário Vian, Porto Alegre (BR)

(72) Inventors: Luciane Macedo De Menezes, Porto Alegre (BR); Tatiana Siqueira Gonçalves, Porto Alegre (BR); André Weissheimer, Porto Alegre (BR); Eduardo Martinelli Santayana De Lima, Porto Alegre (BR); Susana Maria Deon Rizzatto, Porto Alegre (BR); Mário Vian, Porto Alegre (BR)

(73) Assignee: União Brsileira De Educação E Assistência Mantenedora Da PUC RS, Porto Alegre RS (BR)

(21) Appl. No.: 13/996,660

(22) PCT Filed: Dec. 21, 2011
(86) PCT No.: PCT/BR2011/000485

§ 371 Date: Jun. 21, 2013

(30) Foreign Application Priority Data
Dec. 23, 2010 (BR) MU 9002466-4
Dec. 29, 2010 (BR) PI 1005593-2

(51) Int. Cl. A61C 7/04

(52) U.S. Cl. CPC A61C 7/04
USPC 433/4; 433/24

(57) ABSTRACT

An adapter device for extension of miniplates used in orthodontic treatments, which provides for the extension of the plate for the most anterior or posterior and superior or inferior positions, and also the fixation of orthodontic accessories, which can be used for various skeletal anchorage systems available on the market, pliers for the attachment of the device, and a method for extension and attachment of miniplates by use of the adapter devices of the present invention.

### FIELD OF THE INVENTION

The present invention is in the field of Dental materials. More specifically, the present invention provides an adapter device for extension of miniplates used in orthodontic treatments, which provides for the extension of the plate for the most anterior or posterior and superior or inferior positions, and also the attachment of orthodontic accessories, which can be used for various skeletal anchorage systems available on the market. The present invention also provides pliers for the attachment of the device, and method for extension and attachment of miniplates comprising the use of the adapter devices of the present invention.

### BACKGROUND OF THE INVENTION

Currently the orthodontics field has been using, as an aid in orthodontic treatments, temporary anchorage devices that can be clinically both the mini-implants and the miniplates, with different indications. The technology available for the use of miniplates is basically tied to the placement of active devices of the orthodontic appliances such as wires and springs directly on the links of the miniplates that are exposed in the oral environment. There is some diversity in relation to the miniplates that are used by surgeons in terms of trademarks.

One of the difficulties of the use of miniplates is that its position is dependent on the situation in which the oral and maxillofacial surgeon can fix it during surgery, which is subject to certain anatomical peculiarities. Thus, not always the position in which the miniplate is fixed is ideal for carrying out the orthodontic movements. Additionally, there may be limited access to the plates for placing auxiliary devices of the orthodontic treatment.

Another issue that one faces in the daily practice is the frequent need to change the anchor point. I.e., the patient already has a miniplate installed, but during the treatment it is necessary to modify the location of the rigid support, and it automatically implies carrying out another surgery for placement of another miniplate, generating financial and biological costs to the patient.

Another issue that is also important is technology available for the use of miniplates which is basically tied to the placement of active devices of the orthodontic appliances such as wires and springs directly on the links of the miniplates that are exposed in the oral environment. There is often a lack of access to the miniplate for placing the devices of orthodontic appliances.

Therefore, an adapter device was developed such that to be held in position it is pressed and stabilized through a rivet. The present invention therefore also provides an orthodontic pliers which is a modification of a HOW-type (curved or straight) orthodontic pliers for pressing the adapter device.

In dentistry there is the pliers 141, which is a rivet pliers, but its active tip is not appropriate for the purpose employed herein, since its tip is greater than the accessory that has been developed, and is longer than necessary, which may interfere in the position of the accessory.

WO 2006/020911 discloses a pliers comprising a tip modified to create projections in dental devices, in which one tip has a projection and the other tip has a recess able to accommodate this tip.

Document U.S. Pat. No. 7,722,353 discloses a pliers comprising a modified tip which contains pyramidal projections which serve to provide increased retention to the device on the teeth of the patient. Its pyramidal shape facilitates locking the material on the user.

The document U.S. Pat. No. 4,021,922 describes a pliers comprising at its end one tip containing a projection on one side and a recess complementary to this projection, so that when the instrument is closed the projection and the recess are bond together.

The present invention differs from the prior art, among other technical reasons for having two projections at each end of the tip, which has a curvature, and is used to exert pressure in order to join the two portions of an adapter device of the miniplates, thus forming a rivet.

There are documents which propose miniplates with different emergency in the oral cavity (JP2005066068 and JP2004174278), but these do not solve the problem of the need to change the fulcrum and are restricted to the use of systems of the authors of the miniplates.

The document PI 05060403-1 describes a system for orthodontic anchorage with possibility for modification, but with the limitation that any of its variations should be employed with the proper anchoring system, which differs from the present invention which proposes to allow the extension to any kind of skeletal anchorage system, in particular the ones with conventional internal fixation, which are commonly employed.

What is clear from the literature is that there are no documents suggesting or anticipating the teachings of the present invention such that the solution proposed herein, to the eyes of the inventors, has novelty and inventive activity against the prior art.

From the existing problems and the inability to solve them by the prior art, a stent is designed for the miniplates, so that with a plate fixed to the bone the place of support is changed, and a new plate is coupled to the one already fixed to the bone. This fixture and extension element of the miniplates can also provide orthodontic accessories that are directly employed in the corrective orthodontic treatment, supporting the active elements such as springs and elastomers.

### SUMMARY OF THE INVENTION

The present invention provides an adapter and a retainer for the extension of the miniplates used in orthodontic treatments, being also provided a pliers for their attachment and a method for extension and attachment of the miniplates.

The objects of the present invention provide for the extension of the plate, for the most anterior or posterior and superior or inferior positions, and it can be employed for various skeletal anchorage systems available on the market. In a preferred embodiment, the device of the invention provides the extension and attachment of the plate to other regions in addition to receiving the orthodontic attachments necessary for the attachment of the active elements present in corrective orthodontic treatments.

The invention also provides an orthodontic pliers in which its active tip provides the fixation of a rivet from an adapter device of the miniplate. The main advantage of the pliers and the rivet of the invention are to increase the possibilities for mechanical applications of the miniplates, reducing the need for new surgical interventions.

The invention provides a better use of the temporary anchorage devices of the miniplate type, generating biomechanical advantages in the orthodontic treatment, besides reducing or preventing the placement of a new miniplate on the bone in a location next to the previously installed miniplate. This device can be used for various skeletal anchorage systems.

It is an object of the present invention an adapter device comprising:
i) base for compression, optionally comprising regions for welding accessories; and
ii) master cylinder with an end thinner than the body,
   where the outer diameter of the master cylinder is smaller than the diameter of the miniplate hole and the outer diameter of the bases for compression is greater than the diameter of the miniplate hole.

It is another object of the present invention a dental pliers comprising a curved tip out of the plane, in which the end of each one of the tips has projections whose apexes are located so as to exert a pressure directed toward an adapter device of the miniplate, sealing them and creating a rivet.

It is a further object of the present invention a method for extension and attachment of the miniplates comprising the steps of:
a) positioning the miniplates so that the holes remain concentric;
b) insertion of the adapter device in the hole, fixing both miniplates; and
c) compressing the base until the thinner end of the master cylinder is deformed to a diameter greater than the diameter of the miniplates.

When the device is used with an accessory fixed to its base, as for example the pliers of the present invention, the above attachment precedes the step of positioning the device on the miniplate.

These and other objects of the invention will be immediately appreciated by those skilled in the art and by companies with interests in the segment, and will be described in sufficient detail to be reproduced in the following description.

### BRIEF DESCRIPTION OF THE FIGURES

FIG. 1 illustrates a preferred embodiment of the device of the invention, wherein A: master cylinder with the end (B) thinner than the body of the same; C: base for supporting and compression.

FIG. 2 illustrates another preferred embodiment of the device of the invention, wherein A: master cylinder with the end (B) thinner than the body of the same; C: base for supporting and compression wider than the previous presentation (FIG. 1) which allows, besides compression, the attachment of the orthodontic accessories.

FIG. 3 illustrates a perspective view of the pliers.

FIG. 4 illustrates in detail the projection (F) at one curved tip.

FIG. 5 presents a top view of the pliers.

### DETAILED DESCRIPTION OF THE INVENTION

The examples shown herein are intended only to exemplify one of many ways to carry out the invention, but without limiting the scope thereof.

### Adapter Device

The adapter device of the present invention is a device comprising:
I) base for compression; and
II) master cylinder with an end thinner than the body;
   where the outer diameter of the master cylinder is smaller than the diameter of the miniplate hole and the outer diameter of the bases for compression is greater than the diameter of the miniplate hole.

In a preferred embodiment, the base for compression comprises a surface which allows welding/fixing the orthodontic accessories.

Preferably, the base for compression comprises a concavity on its surface where such concavity is preferably conically shaped.

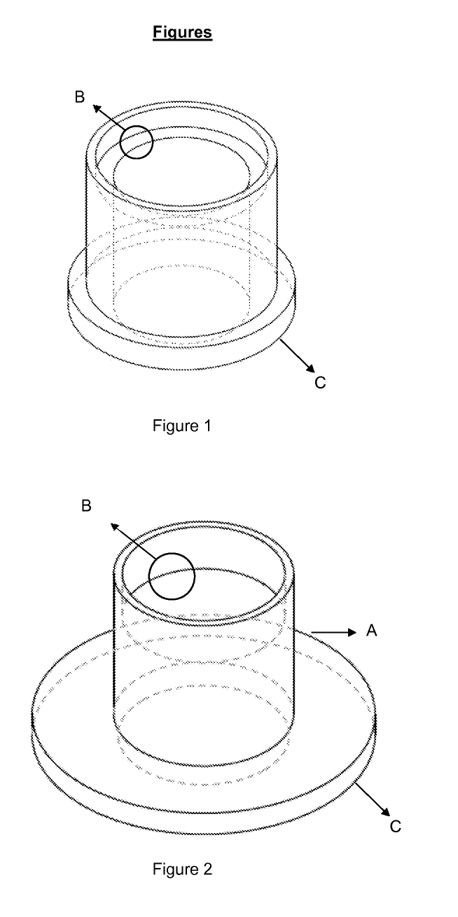

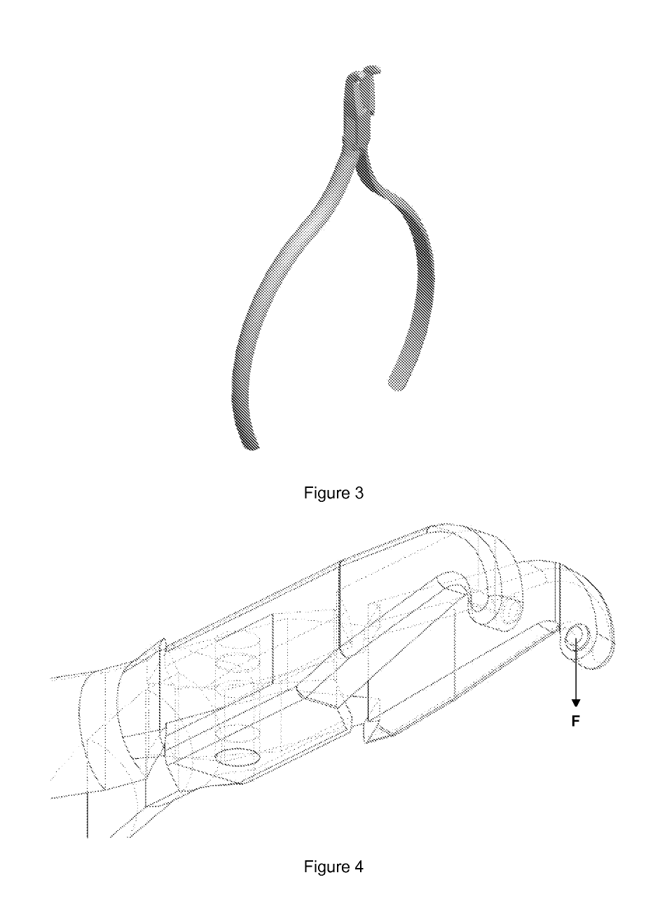

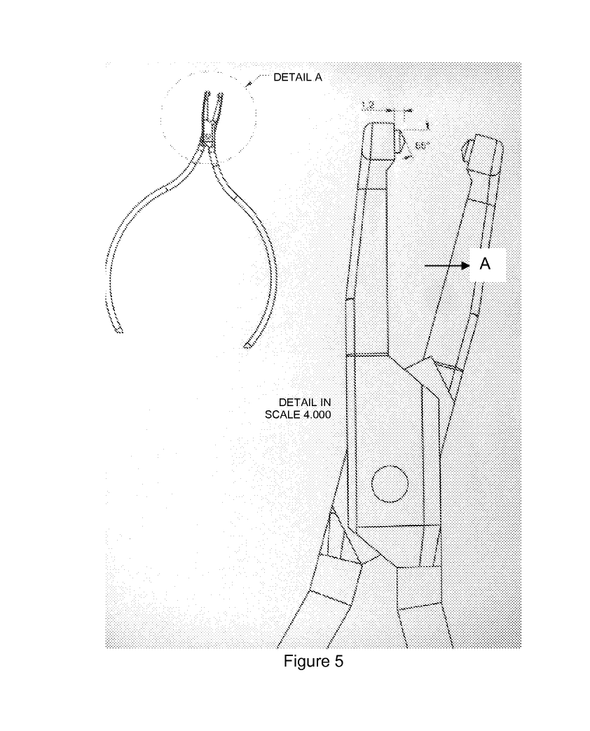

In relation to a second presentation (FIG. 2), it can be used for the extension of the miniplate, when two devices are required (it can be one in FIG. 2 and one in FIG. 1), or it can be used alone, directly fixed to the miniplate which is fixed to the bone, with the accessory welded. Note that the accessory must be welded before the positioning of the device within the miniplate link.

### Pliers

Practical applications of the pliers of the present invention are directly related to Dentistry, Orthodontics and Oral and Maxillofacial Surgery, and it is used for fixing the extender element to the miniplates through a rivet.

The pliers of the invention comprises a curved tip out of the plane, in which the end of each one of the tips has projections whose apexes are located so as to exert a pressure directed toward an adapter device of the miniplate, sealing them and creating a rivet.

FIG. 4 shows in detail the projection of pliers in question. The projection has a wider base than the apex, thereby increasing the pressure at the point of contact with the adapter device, which when pressed locks the miniplates and forms a rivet holding them.

The areas of the industry that can benefit from the invention are, for example, manufacturers of surgical materials, dental materials and orthodontic equipment. Indirectly, the provision of orthodontic, dental and surgical services will be highly beneficial, as it will allow a wider application of temporary anchorage devices, currently in use in orthodontics.

### Extension and Fixation Method

Generally, compression is done on the compression base and on the opposite end where the main hole is located. By applying pressure to the device, the end of the main hole, due to its thinner wall, deforms outwards, thus forming a circle of greater diameter than that of the miniplates, thereby preventing its movement.

The presentation of FIG. 1 provides an extension of the miniplates. Therefore, the operator must place a second miniplate on the one that is already fixed to the bone, so that their holes stay concentric, and then insert the device in such hole. Then both miniplates are fixed by compressing the base and the end of the cylinder (thinner than the body), generating a rivet after compression, which stabilizes the device in position.

Thus, this particular embodiment of the method of the present invention comprises the steps of:
a) positioning the miniplates so that the holes remain concentric;
b) insertion of the adapter device in the hole, fixing both miniplates; and
c) compressing the base until the thinner end of the master cylinder is deformed to a diameter greater than the diameter of the miniplates.

So that the stabilization of the two miniplates occurs in a safe and practice way, it is required to place at least two devices, preventing the miniplate that is not fixed to the bone to rotate about its long axis.

The presentation of FIG. 2 provides, in addition to the extension of the miniplates, their individual use with fixed accessories, being necessary in this latter case, only its position in the interior of a miniplate link and their compression. The compression deforms the thinner end of the cylinder, resulting in stabilization of the rivet. This preferred embodiment of the method of the invention comprises the steps of:
a) fixing the orthodontic accessories.
b) positioning the miniplates so that the holes remain concentric (only for the cases of extension of the miniplates);
c) insertion of the adapter device in the hole, fixing both miniplates; and
d) compressing the base until the thinner end of the master cylinder is deformed to a diameter greater than the diameter of the miniplates.

The device material can be any material known to be compatible with use in the oral cavity.

The orthodontic accessories useful in the present invention comprise any accessories known to the skilled in the art, such as any device used in orthodontic treatment. Preferably, one of the orthodontic accessories used is the pliers of the present invention.

The main practical application is to allow greater versatility of the orthodontic treatment where it is indicated the placement of the miniplates, being able to modify the fulcrum as well as welding the accessories to this new device. The great advantage is that the device can be associated to a large number of commercially available miniplates. The industry of surgical and orthodontic materials will have direct benefits, benefiting the provision of services in the field of Orthodontics and Oral and Maxillofacial Surgery and providing more effective and less invasive treatments.

Those skilled in the art will value the knowledge presented herein, and may reproduce the invention in the arrangements described and other variants falling within the scope of the appended claims.

1. An adapter device for the extension of the miniplates, comprising:
i) a base for compression; and
ii) a master cylinder with an end thinner than the body,
wherein the master cylinder has an outer diameter that is smaller than a diameter of a hole of the miniplate and the base for compression has an outer diameter that is greater than the diameter of the miniplate hole.

2. The device according to claim 1, wherein the base for compression has a surface comprising a concavity.

3. The device according to claim 2, wherein the concavity is of conical shape.

4. Orthodontic pliers for fixing an adapter device for the extension of miniplates, the pliers having side, wherein each side of the pliers comprises a curved tip out of a plane of the side, the curved tips having an identical format to each other, wherein ends of each of the tips have projections which are embedded in the adapter device, the adapter comprising:
i) a base for compression; and
ii) a master cylinder with an end thinner than the body,
wherein the master cylinder has an outer diameter that is smaller than a diameter of a hole of the miniplate and the base for compression has an outer diameter that is greater than the diameter of the miniplate hole.

5. The pliers according to claim 4, wherein the projections have a base and an apex, and the base is wider than the apex.

6. The pliers according to claim 5, wherein the apexes touch each other when the pliers close.

7. A method for the extension and fixation of miniplates using an adapter device for the extension of the miniplates, the method comprising:
providing an adapter comprising:
i) a base for compression; and
ii) a master cylinder with an end thinner than the body,
wherein the master cylinder has an outer diameter that is smaller than a diameter of a hole of the miniplate and the base for compression has an outer diameter that is greater than the diameter of the miniplate hole, and
comprising the steps of:
a) positioning two of the miniplates so that the holes in the miniplates remain concentric;
b) inserting the adapter device in the holes in the miniplates, fixing both miniplates; and
c) compressing the base of the adapter device until a thinner end of the master cylinder is deformed to a diameter greater than the diameter of the miniplates.

8. The method according to claim 7, further comprising using at least two adapter devices for the miniplate.

9. The method according to claim 8, further comprising a step of fixing an orthodontic accessory before positioning the miniplates of step a).
